(19) United States
(12) Patent Application Publication
(10) Pub. No.: US 2014/0372626 A1
(43) Pub. Date: Dec. 18, 2014

(54) TERMINAL, ROUTE GENERATING METHOD, AND COMPUTER-READABLE RECORDING MEDIUM

(71) Applicant: FUJITSU LIMITED, Kawasaki-shi (JP)

(72) Inventors: Hiroaki TAMAI, Kawasaki (JP); Taiji KONDO, Chiba (JP); Katsumi KOBAYASHI, Tokyo (JP); Kobun NAKAJIMA, Tokyo (JP); Masahiro MACHIDA, Tokyo (JP); Satoshi IKEDA, Tokyo (JP); Shigemasa MATSUBARA, Tokyo (JP); Yoshihiko SHIROKURA, Tokyo (JP); Naoto MIYAUCHI, Tokyo (JP)

(73) Assignee: FUJITSU LIMITED, Kawasaki-shi (JP)

(21) Appl. No.: 14/474,664

(22) Filed: Sep. 2, 2014

Related U.S. Application Data
(63) Continuation of application No. PCT/JP2013/055747, filed on Mar. 1, 2013.

(30) Foreign Application Priority Data
Mar. 2, 2012 (JP) 2012-047358

(51) Int. Cl. H04L 12/701

(52) U.S. Cl. CPC H04L 45/00
USPC 709/238

(57) ABSTRACT

A terminal used in a network that constructs a communication route with ad hoc communications is connected to a server via a gateway. The terminal generates downstream route information from the server to a specific terminal based on information relating to occurrence of downstream communication from the server to the specific terminal, the information being included in a header of upstream communication from the specific terminal to the server, and preferentially retains the downstream route information.

### CROSS-REFERENCE TO RELATED APPLICATIONS

This application is a continuation of International Application No. PCT/JP2013/055747, filed on Mar. 1, 2013 which claims the benefit of priority of the prior Japanese Patent Application No. 2012-047358, filed on Mar. 2, 2012, the entire contents of which are incorporated herein by reference.

### FIELD

The embodiments discussed herein are related to a terminal, a route generating method, and a route generating program.

### BACKGROUND

A network using ad hoc communications has been known as a meter reading system reading an electricity meter for domestic use via a network. FIG. 9 is a diagram illustrating an example of a network configuration using ad hoc communications in conventional techniques. As FIG. 9 illustrates, the network includes a plurality of meter reading terminals, a gateway 1, a gateway 2, and a server 3. Each of the meter reading terminals uploads meter reading data to the server 3 through a route connecting the terminals with one another and via the gateway 1 or the gateway 2.

Excluding a gateway for aggregating information into a server and a relay device, the number of meter reading terminals is substantially equal to the network scale configured with the terminals. For example, a network may be configured with over a thousand meter reading terminals, and the amount of memory installed on each meter reading terminal is accordingly limited in view of cost saving and downsizing. A network connecting meter reading terminals with one another in an ad hoc connection is thus needed to operate with a smaller amount of memory compared to a common communication network.

In common ad hoc communications, proactive and reactive approaches are known as methods to construct a route. With the proactive approach, each terminal configuring a network regularly exchanges route information with its neighbor terminal connected with each other at a single-hop distance and retains the route information regardless of whether a transmission request is generated. The proactive approach is generally used for a large-scale network with fixed terminals.

With the reactive approach, each terminal broadcasts a frame including information on itself to a neighbor terminal when a transmission request is generated and generates route information on each transmission request. The reactive approach is usually used for a small-scale network with movable terminals.

Such a technique is lately known that a terminal having received a frame from another terminal generates downstream route information from a destination to a sender based on upstream route information from the sender of the received frame to the destination and retains the downstream route information. Some conventional examples are described in Japanese Laid-open Patent Publication No. 2005-236764 and Japanese Laid-open Patent Publication No. 2011-97458.

Applying such a conventional technique to a system that aggregates data such as a meter reading system, however, problematically causes a route search with broadcasting, and this increases load on the network.

Such a meter reading terminal described above has a limited memory capacity. In other words, the amount of route information retained in the memory of the meter reading terminal is predetermined. When receiving a data transmission request in a state of retaining corresponding route information, the meter reading terminal transmits data according to the retained route information. When receiving a data transmission request in a state of retaining no route information, the meter reading terminal inquires of a neighbor meter reading terminal for a route with broadcasting, constructs route information, and transmits the data. Frequent data transmission requests in the state where each terminal retains no route information cause a rash of broadcasting for a route search from each terminal, and this increases load on the network.

Detailed description with reference to FIG. 10 and FIG. 11 is as follows. FIG. 10 and FIG. 11 are diagrams each illustrating connecting conditions of meter reading terminals and a gateway of a server. In FIG. 10, the gateway of the server is connected with a plurality of meter reading terminals, and a network using ad hoc communications is constructed in a manner of distributing communications in the upstream and downstream directions to and from the gateway. In FIG. 11, a network using ad hoc communications is constructed in a manner that the gateway of the server is connected with a small number of meter reading terminals, each of which diverges into plurality of meter reading terminals.

The configuration of FIG. 10 enables distribution of the memory amount needed to retain upstream and downstream route information from and to each of the meter reading terminals. In other words, the number of routes to be retained by each of the meter reading terminals is comparatively small. This means that a meter reading terminal even with a limited memory capacity is likely to retain downstream route information when receiving a downstream data transmission request, and broadcasting for a route search thus less frequently occurs.

With the configuration of FIG. 11, a meter reading terminal placed at a diverging point needs a quite large amount of memory to retain upstream and downstream route information from and to each of the meter reading terminals. In this case, the needed memory amount is equal to that of a gateway 1 in FIG. 10. The number of routes to be retained by each of the meter reading terminals is comparatively large. This means that a meter reading terminal with a limited amount of memory is unlikely to retain downstream route information when receiving a downstream data transmission request, and broadcasting for a route search may thus frequently occur. The rash of broadcasting for a route search increases load on the network.

### SUMMARY

According to an aspect of the embodiment, a terminal includes a memory; and a processor configured to connect to the memory, wherein the processor executes a process. The process includes generating downstream route information from a server to a specific terminal based on information relating to occurrence of downstream communication from the server to the specific terminal, the information being included in a header of upstream communication from the specific terminal to the server; and preferentially retaining the downstream route information generated at the generating in the memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of the general configuration of a system according to a first embodiment;

FIG. 2 is a diagram illustrating an example of the hardware configuration of a terminal according to the first embodiment;

FIG. 3 is a functional block diagram illustrating the functional configuration of the terminal according to the first embodiment;

FIG. 4 is a diagram illustrating an example of information stored in a route information table;

FIG. 5 is a diagram illustrating an example of a format of a data frame;

FIG. 6 is a diagram for describing an example of a process to retain a route preferentially in a memory;

FIG. 7 is a flowchart illustrating a processing flow when a data frame is received;

FIG. 8 is a diagram for describing an example to change a gateway (GW);

FIG. 9 is a diagram illustrating an example of a network configuration using ad hoc communications in a conventional technique;

FIG. 10 is a diagram illustrating a connecting condition of meter reading terminals and a gateway of a server; and

FIG. 11 is a diagram illustrating another connecting condition of meter reading terminals and a gateway of a server.

### DESCRIPTION OF EMBODIMENTS

Preferred embodiments will be explained with reference to accompanying drawings. The present invention is not limited to these embodiments.

### [a] First Embodiment General Configuration

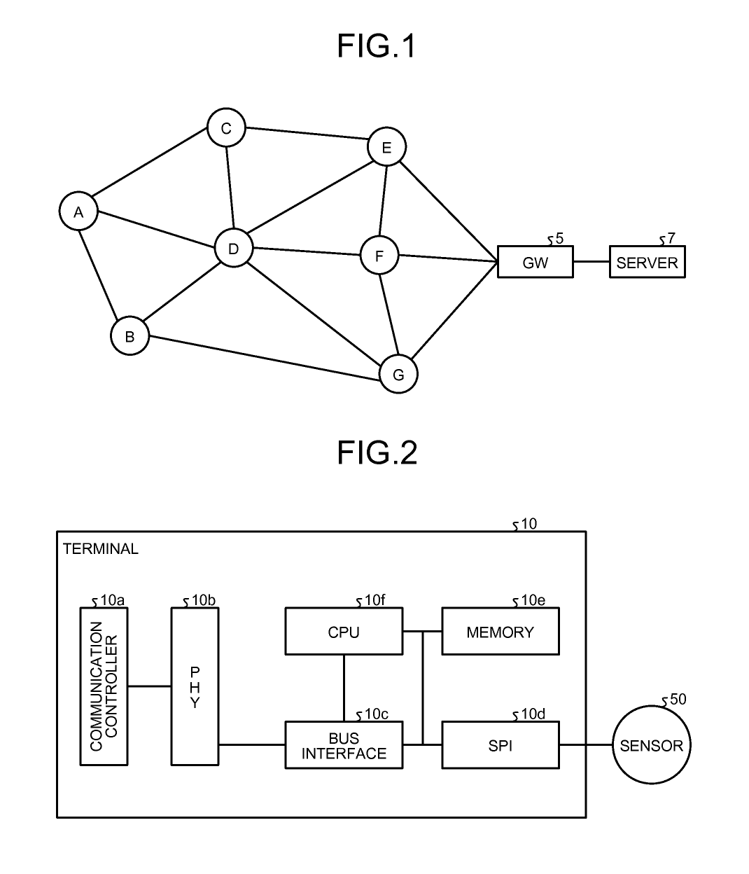

FIG. 1 is a diagram illustrating an example of the general configuration of a system according to a first embodiment. As FIG. 1 illustrates, the system includes terminals A to G, a gateway (GW) 5, and a server 7. The numbers of terminals, servers, and gateways illustrated in the drawings is merely an example, and there is no intention to limit to these numbers. In the embodiment, an example of a network configuration using wireless communications is described; however, the network may be configured with wired communications.

The system illustrated in FIG. 1 is a meter reading system that reads an electricity meter for domestic use via a network. Each of the terminals reads a sensor value sent from a sensor such as an electricity meter with a predetermined time interval and transmits the meter reading data to the GW 5 of the server 7. The server 7 is a management server that aggregates and manages meter reading data transmitted from each of the terminals.

With this system, the terminals and the GW 5 construct a network with ad hoc communications. Specifically, each of the terminals and the GW 5 transmits and receives regular messages such as a hello frame including route information that it retains and information on itself to and from a neighbor terminal connected at a single-hop distance. Each of the terminals selects a route, for example, with higher communication quality out of upstream communication routes to the GW 5 and retains the route in its memory. Furthermore, each of the terminals generates downstream route information based on the upstream communication routed through itself and retains the route information.

The number of terminals illustrated in FIG. 1 may amount to one thousand, and those terminals construct a large-scale network. Each of the terminals is connected to a sensor such as an electricity meter. Each of the terminals thus mounts a memory with a small capacity in order to reduce the cost and size. Because of the limit on the memory capacity, each of the terminals can retain a limited amount of route information, for example, only 128 pieces of route information.

Each terminal thus retains upstream route information to the GW 5 in its memory. With regards to a route to another terminal, when communication occurs in a state of retaining no corresponding route information, each terminal generates downstream route information from the communication and updates the memory. In this process, each terminal performs a first-in first-out (FIFO) control on route information other than the route information to the GW 5.

Each terminal performing such a control generates downstream route information from the server 7 to a specific terminal based on information relating to occurrence of downstream communication from the server 7 to the specific terminal, the information being included in a header of upstream communication from the specific terminal to the server 7. In this process, each terminal preferentially retains the generated downstream route information.

In this way, despite the limit in a retainable amount of route information, each terminal can retain preferentially a downstream route to a specific terminal, through which downstream communication is highly expected to occur, out of upstream communications to the server 7. With this, when a downstream data transmission request is generated, each terminal is likely to retain a corresponding downstream route. This reduces the frequency of broadcasting for a route search and reduces load on the network.

Hardware Configuration

The hardware configuration of the terminals A to G illustrated in FIG. 1 will now be described. Because these terminals have the same configuration, they are collectively referred to as a terminal 10. The gateway (GW) 5 and the server 7 each have similar hardware configurations with common devices, and detailed explanation is thus omitted.

FIG. 2 is a diagram illustrating an example of the hardware configuration of a terminal according to the first embodiment. As FIG. 2 illustrates, the terminal 10 includes a communication controller 10a, a physical layer (PHY) 10b, a bus interface 10c, a serial peripheral interface (SPI) 10d, a memory 10e, and a central processing unit (CPU) 10f.

The communication controller 10a is a processing unit that executes communications with other devices. Examples of the communication controller 10a may include an antenna and a network interface card. The PHY 10b is physical-layer hardware that defines the operation relating to network connections and data transmission at a physical layer and implements communications with a corresponding device through the communication controller 10a. The PHY 10b may be implemented by software.

The bus interface 10c exchanges signals between the CPU 10f, the memory 10e, the PHY 10b, the SPI 10d, and others. The SPI 10d is an interface that connects various kinds of sensors 50 and the terminal 10. Examples of the sensor 50 may include an electricity meter, which may be incorporated in the terminal 10.

Examples of the memory 10e include a read only member (ROM) and a random access memory (RAM). The memory 10e is a memory device that stores therein a program to implement various kinds of processing in the communication method of this embodiment, a route information table, which will be later described, data obtained in the processing, and the like. The CPU 10f is a processing unit that controls various kinds of processing performed by the terminal 10 and further implements various kinds of processing in the communication method of this embodiment.

Functional Configuration

The functional configuration of the terminals A to G illustrated in FIG. 1 will now be described. Because these terminals have the same configuration, they are collectively referred to as the terminal 10. The GW 5 and the server 7 each have similar functional configurations with common devices, and detailed explanation is thus omitted.

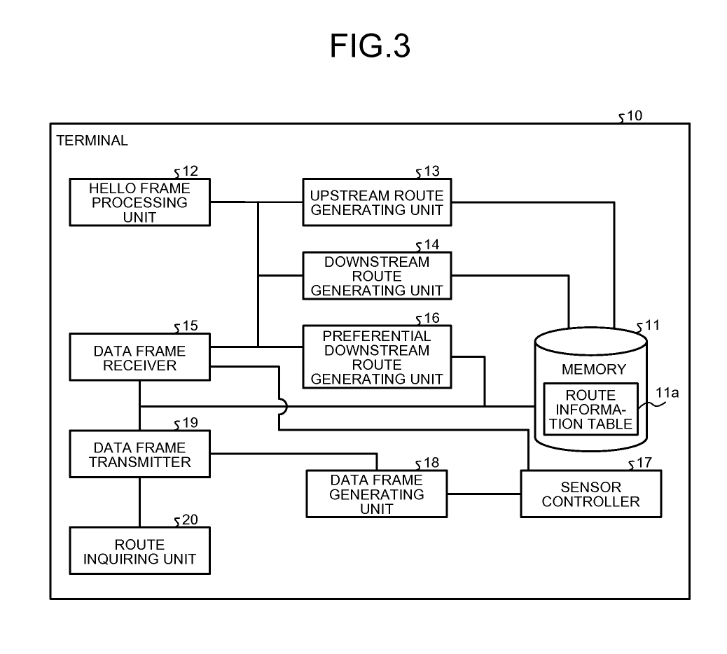

FIG. 3 is a functional block diagram illustrating the functional configuration of the terminal according to the first embodiment. As FIG. 2 illustrates, the terminal 10 includes a memory 11, a hello frame processing unit 12, an upstream route generating unit 13, a downstream route generating unit 14, a data frame receiver 15, and a preferential downstream route generating unit 16. The terminal 10 further includes a sensor controller 17, a data frame generating unit 18, a data frame transmitter 19, and a route inquiring unit 20.

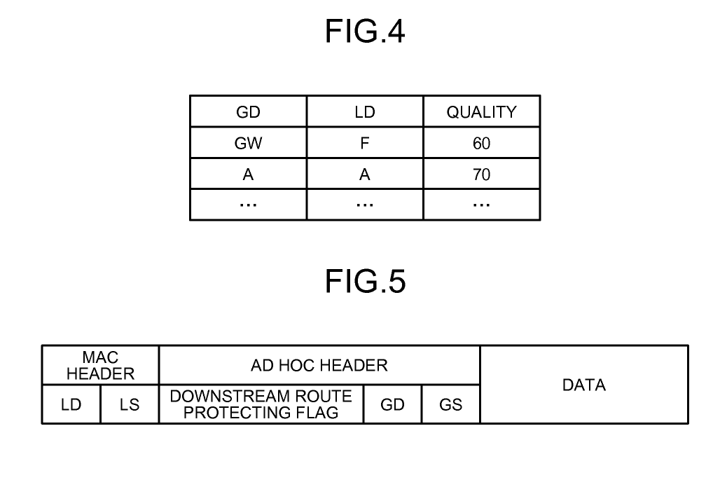

The memory 11 corresponds to the memory 10e illustrated in FIG. 2 and includes a route information table 11a. The memory 11 has a small capacity such as a few kilobytes. The route information table 11a stores therein upstream route information to the GW 5 and downstream route information from the GW 5. Because of the limited capacity of the memory 11, the route information table 11a retains, for example, 128 pieces of route information at maximum. FIG. 4 is a diagram illustrating an example of information stored in the route information table.

As FIG. 4 illustrates, the route information table 11a stores therein “a global destination (GD), a local destination (LD), and quality” in a manner associated with one another. The GD is information indicating a final destination whereas the LD is information indicating a relay point. Either information is indicated as a media access control (MAC) address or the like. The quality is information indicating communication quality such as the received field strength, in which a larger number means higher quality. FIG. 4 illustrates an example of the case where the terminal 10 corresponds to a terminal D in FIG. 1.

FIG. 4 indicates upstream route information to the GW 5 of the terminal 10 as the first entry and downstream route information from the GW 5 of the terminal 10 as another entry. For example, the first entry indicates a route, of which quality has a value of 60, for forwarding a frame that has been addressed to the GW 5 to the terminal F. The next entry indicates another route, of which quality has a value of 70, for forwarding a frame that has been addressed to the terminal A to the terminal A.

The hello frame processing unit 12 is a processing unit that transmits and receives a hello frame. Specifically, the hello frame processing unit 12 generates a hello frame including route information stored in the route information table 11a and broadcasts the generated hello frame. Furthermore, the hello frame processing unit 12 receives a hello frame addressed to the terminal 10 out of hello frames broadcast by a neighbor terminal and the GW 5 and outputs the hello frame to the upstream route generating unit 13. The hello frame processing unit 12 measures the received field strength when it receives a hello frame. The hello frame processing unit 12 discards hello frames addressed to terminals other than the terminal 10.

The upstream route generating unit 13 is a processing unit that generates upstream route information to the GW 5 based on route information included in the hello frame. Specifically, the upstream route generating unit 13 reads out route information with the GD set to the GW 5 from the hello frames input from the hello frame processing unit 12 and selects a piece of route information with the highest received field strength from the read route information addressed to the GW 5. The upstream route generating unit 13 thereafter stores the selected piece of route information in the route information table 11a as upstream route information. In this process, the upstream route generating unit 13 adds a flag or the like to the upstream route information so that the upstream route information is excluded from the first-in first-out (FIFO) control of the memory and stores the upstream route information.

In this way, the upstream route generating unit 13 generates a piece of route information for each gateway and stores the route information in the route information table 11a. The upstream route generating unit 13 further selects a route with higher received field strength when receiving a hello frame. This enables a regular update on the upstream route information.

The downstream route generating unit 14 is a processing unit that generates downstream route information based on upstream route information read by the upstream route generating unit 13. Specifically, the downstream route generating unit 14 performs processing to generate downstream route information based on the upstream communication to the GW 5.

The downstream route generating unit 14 generates downstream route information with the global source (GS) and the local source (LS) of the upstream data frame that is not an object to be preferentially retained and has been input from the preferential downstream route generating unit 16, as the global destination (GD) and the local destination (LD), respectively, and stores the downstream route information in the route information table 11a. In this process, the downstream route generating unit 14 generates downstream route information if the GD of the received data frame is GW.

If the capacity of the route information table 11a to store route information is full, the downstream route generating unit 14 deletes stored downstream route information from the route information table 11a in accordance with the first-in first-out (FIFO) control and stores new downstream route information. The route information table 11a can store, for example, up to 128 pieces of downstream route information.

The data frame receiver 15 is a processing unit that receives a data frame transmitted from another terminal to the terminal 10 with meter reading data and an instruction frame transmitted from the server 7 to the terminal 10. Specifically, when the data frame receiver 15 receives a data frame including meter reading data, the data frame receiver 15 outputs the data frame to the data frame transmitter 19 to request to forward the data frame to the GW 5. Furthermore, when the data frame receiver 15 receives the data frame including meter reading data, the data frame receiver 15 outputs the data frame to the preferential downstream route generating unit 16 to request generation of downstream route information to be preferentially retained. The data frame receiver 15 discards data frames addressed to terminals other than the terminal 10.

When the data frame receiver 15 receives an instruction frame transmitted from the server 7, the data frame receiver 15 extracts the GD from the header of the frame and determines whether the frame is addressed to the host terminal. If the data frame receiver 15 determines that the instruction frame is addressed to the host terminal, the data frame receiver 15 executes the instruction included in the instruction frame. For example, if the instruction frame includes an instruction of retransmission of meter reading data, the data frame receiver 15 instructs the sensor controller 17 to acquire the meter reading data. If the instruction frame includes an instruction of a restart, the data frame receiver 15 restarts the terminal 10 or the sensor 50.

The preferential downstream route generating unit 16 is a processing unit that generates downstream route information to be preferentially retained. Specifically, the preferential downstream route generating unit 16 generates, from upstream route information, downstream route information from the server 7 to a specific terminal based on information relating to occurrence of downstream communication from the server 7 to the specific terminal, the information being included in the header of the upstream communication from the specific terminal to the server 7. In more specific, when such upstream communication occurs that has a sign of occurrence of downstream communication, the preferential downstream route generating unit 16 performs a control to retain the reverse route of the upstream communication for a certain period. The preferential downstream route generating unit 16 adds a flag, which instructs to exclude the generated downstream route information from a target of the first-in first-out (FIFO) control for a certain period, to the downstream route information and stores the downstream route information in the route information table 11a.

The generation process of the downstream route information to be retained preferentially will now be described. FIG. 5 is a diagram illustrating an example of a format of a data frame. As FIG. 5 illustrates, the data frame consists of a media access control (MAC) header, an ad hoc header, and data (a payload). The MAC header has an LD indicating the next forwarding address and an LS indicating a forwarder of the data frame. The ad hoc header has a downstream route protecting flag indicating whether to generate downstream route information to be retained preferentially, a GD indicating the final destination, and a GS indicating a terminal first transmitting the frame.

The preferential downstream route generating unit 16 that has received such a frame determines whether the downstream route protecting flag of the frame is valid. If the downstream route protecting flag is valid, the preferential downstream route generating unit 16 extracts information to be stored as each of the GD, GS, LD, and LS from the frame and generates downstream route information with the GD set to the GS, the GS to the GD, the LD to the LS, and the LS to the LD. If the preferential downstream route generating unit 16 determines that the downstream route protecting flag of the frame is invalid, the preferential downstream route generating unit 16 outputs the frame to the downstream route generating unit 14.

The operation is now described citing a case where the terminal 10 receives a data frame transmitted from the terminal A to the GW 5 from the terminal F. In this case, the GS corresponds to the terminal A, the GD corresponds to the GW 5, the LD corresponds to the terminal 10, and the LS corresponds to the terminal F. The preferential downstream route generating unit 16 generates downstream route information with the GD set to the terminal A, the GS set to the GW 5, the LS set to the terminal 10, and the LD set to the terminal F. If the preferential downstream route generating unit 16 receives an instruction frame transmitted from the GW 5 to the terminal A, the preferential downstream route generating unit 16 generates a route for forwarding the instruction frame to the terminal F.

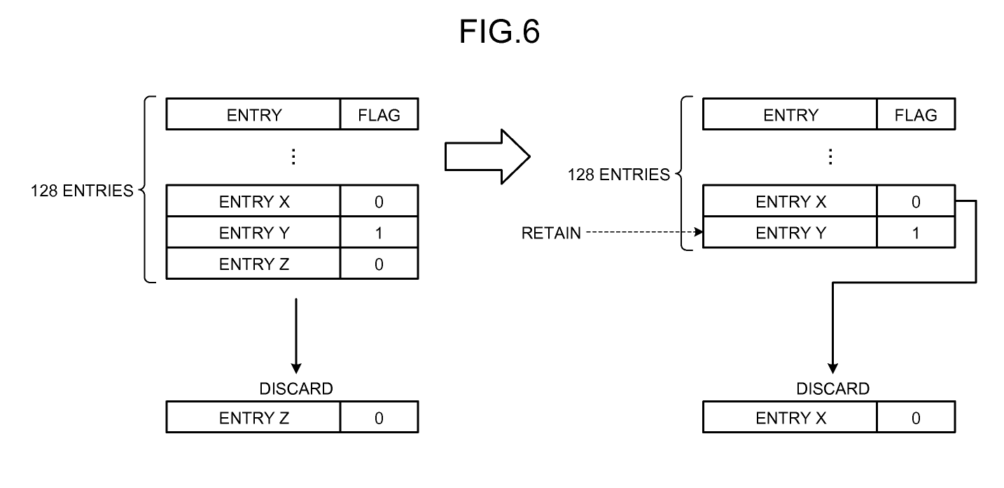

The following is an example of the case where a route is preferentially retained in a memory. FIG. 6 is a diagram illustrating an example of the case where a route is preferentially retained in a memory. The description is based on the assumption that the memory is capable of retaining 128 pieces of downstream route information in addition to an upstream communication route to the GW 5 and that an entry is input from the top and deleted from the bottom in FIG. 6. As FIG. 6 illustrates, a flag is added to each entry on the route information table 11a. The flag is information indicating whether to retain preferentially a route. The downstream route generating unit 14 adds a flag of 0 to a generated entry whereas the preferential downstream route generating unit 16 adds a flag of 1 to a generated entry.

If all of the 128 entries have the flag of 1, such a control may be performed that discards a frame with a valid downstream route protecting flag. For example, if the terminal 10 receives an upstream data frame having a valid downstream route protecting flag in a condition where all of the 128 entries have the flag of 1, the terminal 10 discards the data frame instead of forwarding it to the GW 5. In other words, if the terminal 10 can delete no entries from the memory 11 and the memory 11 does not have space to store downstream route information any more, the terminal 10 controls upstream communication that is likely to cause downstream communication not to reach the GW 5.

This prevents generation of downstream communication and accordingly reduces the frequency of broadcasting to generate downstream route information. If the terminal 10 does not perform the control described above and receives an upstream data frame having a valid downstream route protecting flag in the state where the memory 11 is full, the terminal 10 forwards the data frame to the GW 5. In response to this, the GW 5 transmits a frame for downstream communication. The terminal 10 receives the frame for downstream communication and performs broadcasting for a route search because the terminal 10 retains no downstream route information. This causes congestion of the network.

Therefore, when the terminal 10 receives an upstream data frame having a valid downstream route protecting flag in a condition where the terminal 10 can delete no entries from the memory 11, the terminal 10 discards the data frame as described above, thereby preventing generation of downstream communication. This reduces the frequency of broadcasting to generate downstream route information.

In this process, the downstream route generating unit 14 or the preferential downstream route generating unit 16 determines whether the lowest entry, that is, the oldest entry has a flag of 1 when storing generated downstream route information. If the oldest entry Z has a flag of 0 as illustrated in the left diagram of FIG. 6, the downstream route generating unit 14 or the preferential downstream route generating unit 16 discards the entry Z and stores a new entry.

If the oldest entry Y has a flag of 1 as illustrated in the right diagram of FIG. 6, the downstream route generating unit 14 or the preferential downstream route generating unit 16 determines the entry Y as an object not to be deleted. If the next oldest entry X has a flag of 0, the downstream route generating unit 14 or the preferential downstream route generating unit 16 discards the oldest entry X and stores a new entry. This makes it possible to retain preferentially downstream route information generated from upstream communication that is likely to cause downstream communication. Furthermore, the preferential downstream route generating unit 16 changes the flag from 1 to 0 after a predetermined time such as five minutes has passed. After this process, the first-in first-out (FIFO) control is applied even to a downstream route generated by the preferential downstream route generating unit 16.

With reference back to FIG. 3, the sensor controller 17 is a processing unit that collects meter reading data of, for example, an electricity sensor connected to the terminal 10. Specifically, the sensor controller 17 regularly collects meter reading data and outputs the data to the data frame generating unit 18. When the sensor controller 17 receives an instruction to reread the meter from the data frame receiver 15, the sensor controller 17 collects meter reading data and outputs the data to the data frame generating unit 18, even if it is not the regular timing for collecting meter reading data.

The data frame generating unit 18 is a processing unit that generates a data frame with meter reading data as a payload. Specifically, when the sensor controller 17 inputs meter reading data, the data frame generating unit 18 refers to the route information table 11a to extract a route to the GW 5. The data frame generating unit 18 thereafter sets route information to the GW 5 on the media access control (MAC) header and the ad hoc header, generates a data frame with data including the meter reading data, and outputs the data frame to the data frame transmitter 19.

For example, in the case where the route information illustrated in FIG. 4 is stored, the data frame generating unit 18 sets the terminal F for the LD and the terminal A for the LS of the MAC header, and 0 for the downstream route protecting flag, the GW 5 for the GD, and the terminal A for the GS of the ad hoc header and generates a data frame. Examples of the case where the data frame generating unit 18 sets 1 (valid) for the downstream route protecting flag of the ad hoc header include the case where the terminal 10 transmits first meter reading data after the terminal 10 has been powered on. Setting 1 (valid) for the downstream route protecting flag enables a determination that the downstream route information generated from the upstream frame is likely to be used in the near future.

The data frame generating unit 18 transmits to the GW 5 a data frame with the downstream route protecting flag of the ad hoc header set to 1 at any timing besides the timing to transmit the meter reading data. In this case, the payload may be empty. Examples of the timing include the case where a master station, that is, the GW terminating the ad hoc network is changed, the case where the terminal 10 makes the first communication after the terminal 10 is installed to an electricity sensor and the like, and the case where the terminal 10 makes the first communication after recovery from a power outage.

With reference back to FIG. 3, the data frame transmitter 19 is a processing unit that transmits a data frame to its destination. Specifically, the data frame transmitter 19 broadcasts a data frame input from the data frame generating unit 18 to a terminal designated as the LD of the data frame.

The data frame transmitter 19 broadcasts a data frame input from the data frame receiver 15 to a neighbor terminal in accordance with route information stored in the route information table 11a. The process is now described in detail with reference to FIG. 4 as an example. In the description, the terminal F corresponds to the terminal 10. Given that the data frame transmitter 19 receives a data frame with the GD set to the GW 5, the LD set to the terminal 10, and the LS and the GS each set to the terminal A, the data frame transmitter 19 changes the settings of the LS and the LD of the data frame, which has been transmitted from the terminal A, to the terminal 10 and the terminal F, respectively, and broadcasts the data frame.

With regards to a downstream instruction frame input from the data frame receiver 15, the data frame transmitter 19 determines whether the route information to the destination (GD) designated by the instruction frame is stored in the route information table 11a. If the route information to the destination designated by the instruction frame is stored in the route information table 11a, the data frame transmitter 19 changes the setting of the LS to the terminal 10 and the setting of the LD to a relay terminal as the next destination according to the stored route information. The data frame transmitter 19 thereafter broadcasts the instruction frame to its destination.

If no route information to the destination designated by the instruction frame is stored in the route information table 11a, the data frame transmitter 19 instructs the route inquiring unit 20 to start the processing of route inquiry. In accordance with the route information generated by the route inquiring unit 20, the data frame transmitter 19 changes the setting of the LS to the terminal 10 and the setting of the LD to a relay terminal as the next destination and broadcasts the instruction frame to its destination.

With reference back to FIG. 3, the route inquiring unit 20 is a processing unit that broadcasts a frame for a route search and, based on the response, constructs a downstream route. Specifically, when the route inquiring unit 20 receives an instruction to start processing from the data frame transmitter 19, the route inquiring unit 20 broadcasts a frame for a route search. In other words, the route inquiring unit 20 executes a reactive route configuration in ad hoc communications. The executed processing is similar to a common reactive route configuration, and detailed description will be thus omitted. The route inquiring unit 20 stores the route information generated based on the response to the frame for a route search in the route information table 11a in accordance with the first-in first-out (FIFO) control.

Processing Flow

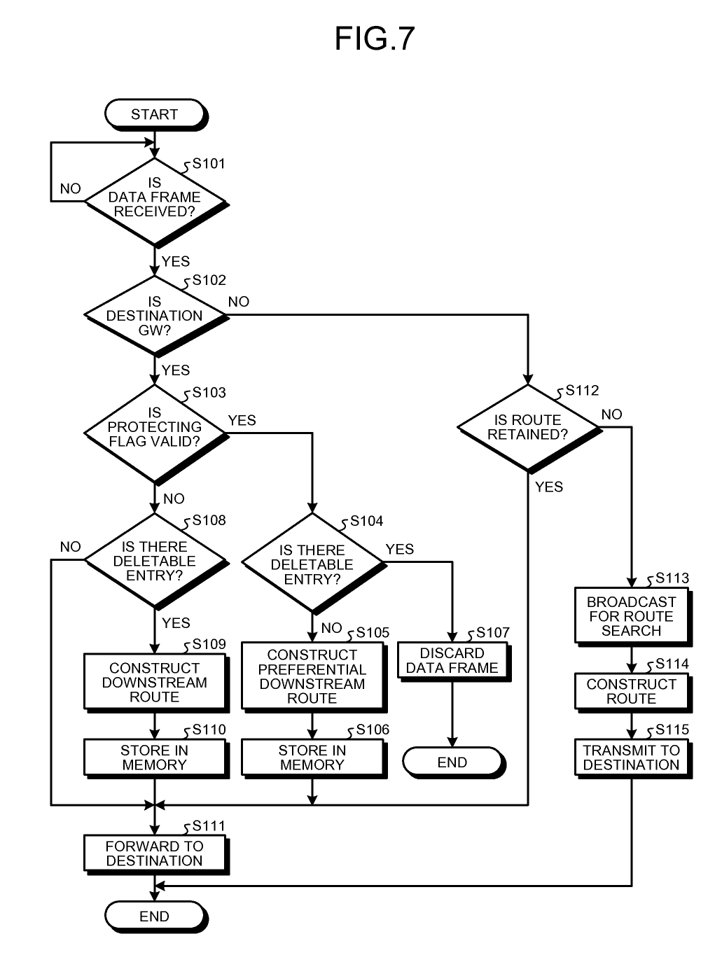

FIG. 7 is a flowchart illustrating a processing flow when a data frame is received. As FIG. 7 illustrates, when the data frame receiver 15 of the terminal 10 receives a data frame (Yes at Step S101), the data frame receiver 15 refers to the ad hoc header of the data frame and determines whether the destination is the GW 5 (Step S102).

If the data frame receiver 15 determines that the destination of the data frame is the GW 5 (Yes at Step S102), the preferential downstream route generating unit 16 refers to the ad hoc header of the data frame and determines whether the downstream route protecting flag is valid (Step S103).

If the preferential downstream route generating unit 16 determines that the downstream route protecting flag is valid (Yes at Step S103), the preferential downstream route generating unit 16 determines whether the route information table 11a includes therein a deletable entry (Step S104). In other words, the preferential downstream route generating unit 16 determines whether an entry with a flag of 0 is stored in the route information table 11a.

If the preferential downstream route generating unit 16 determines that a deletable entry is stored (Yes at Step S104), the preferential downstream route generating unit 16 constructs downstream route information to be preferentially retained based on the upstream route information included in the received data frame (Step S105) and stores the generated downstream route information in the route information table 11a of the memory 11 as preferential route information in accordance with the first-in first-out (FIFO) control (Step S106).

If the preferential downstream route generating unit 16 determines that no deletable entries are stored (No at Step S104), the preferential downstream route generating unit 16 discards the received data frame (Step S107).

If the preferential downstream route generating unit 16 determines that the downstream route protecting flag of the received data frame is invalid (No at Step S103), the downstream route generating unit 14 determines whether the route information table 11a includes therein a deletable entry (Step S108). In other words, the downstream route generating unit 14 determines whether an entry with a flag of 0 is stored in the route information table 11a.

If the downstream route generating unit 14 determines that a deletable entry is stored (Yes at Step S108), the downstream route generating unit 14 constructs usual downstream route information based on the upstream route information included in the data frame (Step S109) and stores the constructed downstream route information in the route information table 11a of the memory 11 as usual route information in accordance with the first-in first-out (FIFO) control (Step S110).

When the construction of the downstream route information is completed, the data frame transmitter 19 specifies route information to the GW 5 in the route information table 11a and unicasts the received data frame to its destination according to the specified route information (Step S111).

If the downstream route generating unit 14 determines that no deletable entries are stored in the route information table 11a (No at Step S108), the downstream route generating unit 14 unicasts the received data frame to the GW 5 as its destination without constructing a downstream route (Step S111).

With reference back to Step S102, if the data frame receiver 15 determines that the destination of the data frame is not the GW 5 (No at Step S102), the data frame transmitter 19 determines whether the route information to the destination specified from the data frame is stored in the route information table 11a (Step S112).

If the data frame transmitter 19 determines that the route information to the destination is stored in the route information table 11a (Yes at Step S112), the data frame transmitter 19 unicasts the received data frame to its destination according to the specified route information (Step S111).

If the data frame transmitter 19 determines that no route information to the destination is stored in the route information table 11a (No at Step S112), the route inquiring unit 20 broadcasts a frame for a route search (Step S113).

The route inquiring unit 20 thereafter constructs a route to the destination of the data frame based on the responses to the frame for a route search (Step S114). In this process, the route inquiring unit 20 stores the generated downstream route information in the route information table 11a as usual route information in accordance with the first-in first-out (FIFO) control. The data frame transmitter 19 unicasts the received data frame to its destination using the route information generated by the route inquiring unit 20 (Step S115).

### Advantageous Effects

Each terminal is capable of constructing a reverse route of upstream route information used when the server 7 collects meter reading data as a downstream route to each terminal. The meter reading data is regularly collected, and each terminal can thus retain a currently used upstream route to the GW 5 and a downstream route generated based on the upstream communication.

Each terminal is also capable of anticipating the condition where the server 7 performs a terminal control in the near future after an upstream communication occurs and of deciding whether to construct a downstream route when the server 7 collects meter reading data. When a terminal anticipates the terminal control, the terminal can retain preferentially a downstream route to the terminal in the route information table 11a. This increases the possibility that the terminal retains a corresponding downstream route when receiving a downstream data transmission request and thus reduces the frequency of broadcasting for a route search, whereby reducing load on the network.

### [b] Second Embodiment

In the first embodiment, examples of the case where the downstream route protecting flag is valid are given as cases where a gateway (GW) terminating an ad hoc network is changed, where the terminal 10 makes the first communication after the terminal 10 is installed to an electricity sensor and the like, and where the terminal 10 makes the first communication after recovery from a power outage. The case where a gateway (GW) terminating an ad hoc network is changed will be described in detail as an example.

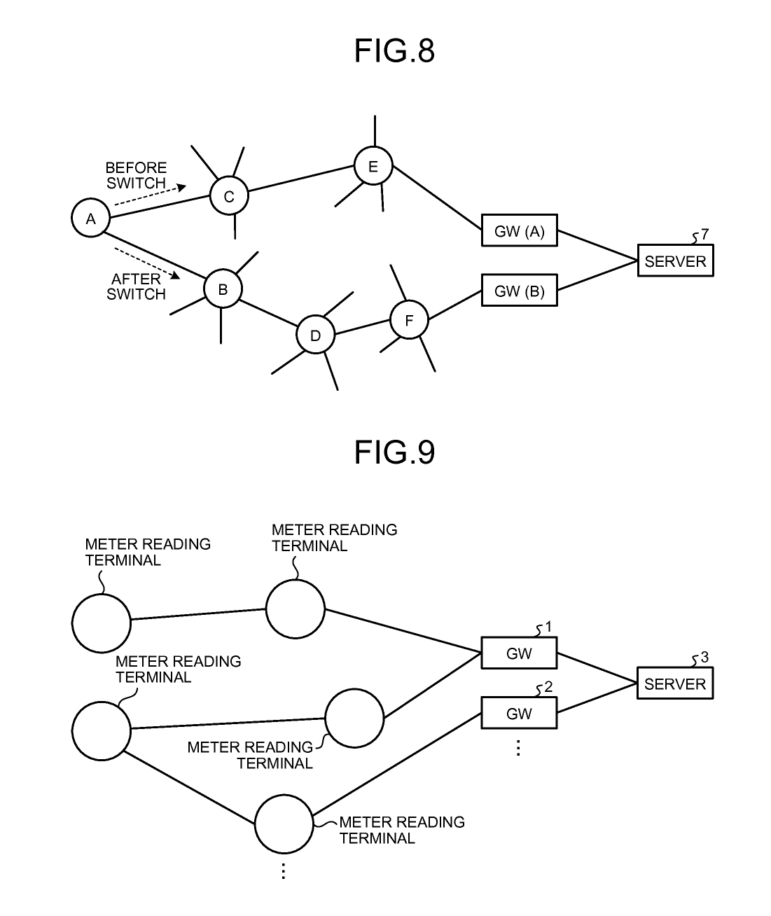

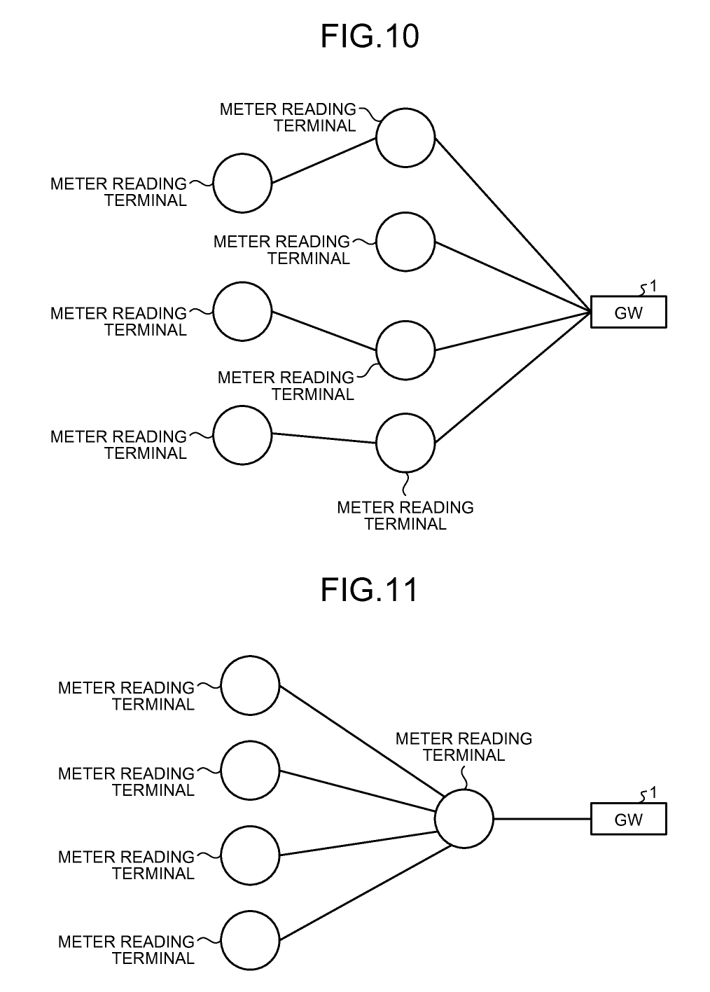

FIG. 8 is a diagram illustrating an example of the case where a GW is changed. As FIG. 8 illustrates, the system includes the terminals A to F, a gateway (GW) (A), a gateway (GW) (B), and the server 7. Each terminal makes routine communications by transmitting and receiving a hello frame to and from a neighbor terminal. This makes it possible to monitor the quality of communication to each gateway connected to the server, and to change a gateway to connect to the server depending on the quality of a route.

The terminal A retains an upstream communication route (A) through the terminals C and E and the GW (A), and an upstream communication route (B) through the terminals B, D, F, and the GW (B). Because the upstream communication route (A) to the GW (A) is assumed to have higher quality than the upstream communication route (B) to the GW (B), the terminal A transmits a data frame to the server 7 through the upstream communication route (A).

The server 7 assigns a sequence number to each gateway, thereby managing a terminal connected to the gateway. Specifically, the server 7 assigns a sequence number to a terminal as a sender (GS) in the order of receipt of a data frame transmitted from the GW (A) and informs the sender of the number. Similarly, the server 7 assigns a sequence number to a terminal as a sender (GS) in the order of receipt of a data frame transmitted from the GW (B) and informs the sender of the number.

The sequence number is used for management of terminals such as management of the number of terminals connected to a gateway. In another case, the sequence number is used to control the transmission timing of each of the terminals under the gateway, thereby preventing congestion of the network caused by the terminals transmitting data frames at a time. For example, the server 7 instructs the sequence numbers 1 to 10 of the GW (A) to transmit data frames from a time A to a time B and instructs the sequence numbers 11 to 20 of the GW (A) to transmit data frames after the time B.

When a terminal changes a gateway to connect to, the server 7 assigns a new sequence number. The server 7 thus generates downstream communication to send a sequence number whenever upstream communication to inform the change of the gateway occurs.

If the terminal A detects that a route to the GW (B) has higher quality than a route to the GW (A), the terminal A informs the server 7 of the change of the GW regardless of whether it is the timing to transmit a data frame of meter reading data or a hello frame. In specific, the terminal A transmits a data frame with the downstream route protecting flag set valid to the server 7 and generates upstream communication from the terminal A to the GW (B). In response to this, each of the terminals B, D, and F, which exist between the terminal A and the GW (B), generates downstream route information to be preferentially retained in forwarding the data frame and retains the route information in its memory. This enables the terminals B, D, and F each to retain a route for the downstream communication that inevitably occurs. This accordingly reduces the frequency of broadcasting for an unneeded route search, thereby reducing load on the network.

The communication quality is not necessarily limited to the received field strength. Factors such as load on the terminal, congestion of the network, and delay of the data arrival may be used as the communication quality. These factors may result from frequent broadcasts to search a downstream communication route. However, use of the methods of the first embodiment and the second embodiment can reduce the frequency of broadcasting to search a downstream communication route. This, for example, eliminates unneeded change of a gateway and thus increases stability of the network.

### [c] Third Embodiment

Embodiments have been described; however, the prevent invention can be embodied in various forms different from the above described embodiments. Such different embodiments will be described as follows.

Anticipation

The operation described in the embodiments that sets the downstream route protecting flag valid is merely an example of the case that anticipates occurrence of downstream communication based on upstream communication. The way of anticipation is not limited to the operation described in the embodiments. The anticipation is applicable, for example, to a terminal requesting a response from a server. Specifically, when requesting an acknowledgement (ACK) to confirm that important data has been correctly received by the server, a terminal may set the downstream route protecting flag valid in transmitting the data. Alternatively, when requesting the server to address a failure, the terminal may set the downstream route protecting flag valid in transmitting data to report detection of the failure.

System

In the processing described in the embodiments, the whole or a part of the processing, which has been described as an automated operation, may be executed manually. Similarly, the whole or a part of the processing described as a manual operation may be executed automatically using a known method. Furthermore, the processing procedure, the control procedure, the specific names, and the information including various kinds of data and parameters, which are indicated in the description and the drawings, can be replaced arbitrarily unless otherwise specifically noted.

Respective components included in each of the devices illustrated in the drawings are depicted in functional and conceptual views, and those are not necessarily configured physically as illustrated in the drawings. In other words, the specific forms of distribution and integration of the devices are not limited to the forms illustrated in the drawings. The whole or a part of the devices can be distributed or integrated functionally or physically in any unit, depending on circumstances such as various kinds of load and conditions of use. All or any part of the processing functions performed in each device may be implemented by a central processing unit (CPU), a program analyzed and executed by the CPU, and hardware with wired logic.

According to an aspect of the embodiment, a terminal, a route generating method, and a route generating program disclosed herein exert the effect of reducing load on the network.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal comprising:
a memory; and
a processor configured to connect to the memory, wherein the processor executes a process including:
generating downstream route information from a server to a specific terminal based on information relating to occurrence of downstream communication from the server to the specific terminal, the information being included in a header of upstream communication from the specific terminal to the server; and
preferentially retaining the downstream route information generated at the generating in the memory.

2. The terminal according to claim 1, wherein the generating includes generating the downstream route information from the server to the specific terminal based on the upstream route information included in the header of the upstream communication generated first after a start-up of the specific terminal.

3. The terminal according to claim 1, wherein the generating includes generating the downstream route information from the server to the specific terminal based on the upstream route information included in the header of the upstream communication generated first after recovery of the specific terminal from a power outage.

4. The terminal according to claim 1, wherein the generating includes generating the downstream route information from the server to the specific terminal based on the upstream route information included in the header of the upstream communication and indicating switching from a relay device to another relay device, the relay device terminating a network that constructs a communication route via ad hoc communications and connecting the network and the server.

5. A route generating method comprising:
generating, using a processor, downstream route information from a server to a specific terminal based on information relating to occurrence of downstream communication from the server to the specific terminal, the information being included in a header of upstream communication from the specific terminal to the server; and
preferentially retaining the downstream route information in a memory, using the processor.

6. A non-transitory computer-readable recording medium having stored therein a route generating program causing a computer to execute a process comprising:
generating downstream route information from a server to a specific terminal based on information relating to occurrence of downstream communication from the server to the specific terminal, the information being included in a header of upstream communication from the specific terminal to the server; and
preferentially retaining the downstream route information in a memory.
